(19) United States
(12) Patent Application Publication
(10) Pub. No.: US 2003/0173455 A1
(43) Pub. Date: Sep. 18, 2003

(54) Ground-effect aircraft and airfield

(76) Inventor: Zoltan Herpay, London (GB)

Correspondence Address: DR ZOLTAN HERPAY, 28 Dudley Court, 36 Endell Street, London, WC2H 9RD, GB

(21) Appl. No.: 10/100,734

(22) Filed: Mar. 18, 2002

(51) Int. Cl. B64C 15/00; B64C 29/00

(52) U.S. Cl. 244/12.1

(57) ABSTRACT

A Ground-effect Aircraft and Airfield, both for serving sea-sides located mass-transportation in a manner that this aircraft is alway flying very near to the sea-level and always landing on sea-side resources on its own specially designed framed sea-strip, inside which the water is always mirror smooth, having a wide span for carrying about 500 passengers in the wing, quickly removable from the long and wide double-bubble fuselage, the fuel-tank, whose nose has a canard wing, its tail has a big, singular, specially designed engine, quickly removeable from the main wing, which is very quickly refillable, having two stabilizer tail plains, each with two knife-edged fuselages, using inflatables for the quick lifting up of the wing in changing a new fuselage, making the flying capacity more economical, thus, while it is the wing which is the heart of the matter, it is served by twice as many fuselages.

This invention relates to Ground-Effect Aircraft and Airfield as a systemic unity.

The great advantage of ground-effect flight is known since my childhood in Hungary, where the old friends of Von Karman discovered it. Today many research workers and many big companies are thinking about its future, but none could succeed because the art of aeronautics is totally governed by the militarily tuned aero-industries, in which economy has no importance, and the profit is felt to be the safest, if air-transport is maintained in very high cealing-flight with the tragical side-effect that in the case of a high flight-explosion there is no way to save any parts as they are falling and accelarating. Airfields are also known even for water-aircafts, but none of them are useful for the aircraft I am going to describe here. Most of the airfields are designed for the aircrafts, using landing geers, and the landing geers are very heavy. Most of the crashes are coused by them. Because they are getting to be greater and greater on concrete covered land, there is a feer that soon there would be no useful land area for agricultural purposes.

According to the present invention there is provided a large Ground-Effect Aircraft and an Airfield as a systemic unity, by which the existing mass-transportation could be improved, as most of the air-travellers are seeking sea-side or lake-side resources, for like the old townships, these are built on water-sides. Since the Earth has a greater oceanic surface area, I dare to say that the future is open for the proper development of the ground-effect aircraft and its specially created airfield, which could be located much nearer to the big sea-side towns, without causing extra air-pollution. Most of the big intercontinental flights are conducted over oceaninc areas, but in cases of troubles the aircrafts could not land on the sea. The presently propose aircarft could offer a great improvement in this, for it could land on any sea surface formations, but of course, most easily on a smooth sea water, well framed from wave-motions with floating breakwaters. The modification in the ground-effect aircraft is not very much, but it is crucial. The heart of the matter is the wing, which is the mass-transporter that could carry over 500 passengers. It is wide in span. It has a long chord, and it is thick. In its frontal one quarter there is a three-lined passengers-sit with a wide panoramic view on the leading edge, and a sufficiently tall central corridor for a fast reloading. Behind this corridor there are plenty of rooms for the passengers behind every 10 or 12 sits. This wing is quickly removable from the big double-bubble fuselage at arrival, the fuselage is pulled out.

A new, already filled fuselage arrives, and the quickly reloaded wing could fly within minutes. The fuselage has a big singular rocket-like engine and two side-keels at its bottom part. At its nose there is a wide canard-plane.

There is a good possibility to make a specific improvement in the fuselage, which have to be useful for landing on any sea-surfaces with its two lower-side keels, designed for the development of a very strong ground-effect in forced landing on rough sea, as a calm sea is not always easy to find before a quick landing.

A specific embodiment of of the invention will now be described by way of example with reference to the accompanying drawing in which:

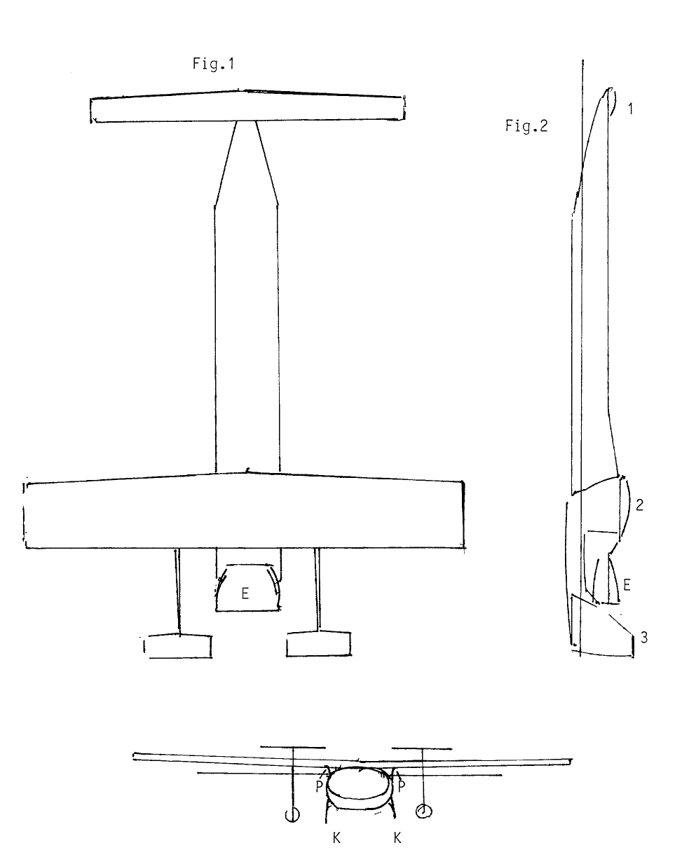

FIG. 1 shows the top planar cross-section of the aircraft.

FIG. 2 shows the side-view in water.

FIG. 3 shows the frontal or the back-view.

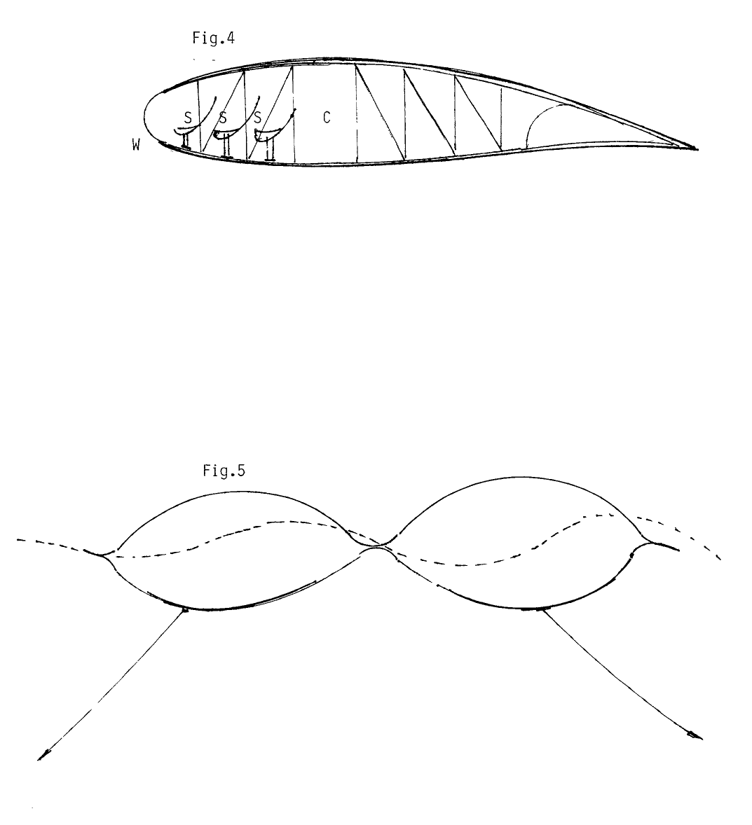

FIG. 4 shows the profile of the wing, as it is left behind by the fuselage in a reloading area.

FIG. 5 shows the cross-section of a singular cushion-like floating breakwater alongside of a watery landing strip.

Referring to FIG. 1 the wide span, great aspect-ratio wing is emphasized with the even wider canard wing. Tail-planes are proposed merely for making the wing more stable in flight, less vulnerable for flutter. the side-verticals of the tail-planes are also stabilizing the machine on open sea.

Referring to FIG. 2 the differences of the heights of the wings and the tails are made clear with number 1, 2, and 3. Notice the large rocket-like tail engine E.

Referring to FIG. 3 the double-bubble shaped fuselage is emphasized with the two lower side-keels, important in the generating of a strong air-cushion when required. K. The separating points P are also shown.

Referring to FIG. 4 the profile of the wing is shown together with its major structural parts, as three lines of sittings are positione behind each other S, and a great panoramic view is ensured for the passengers over the whole flight by the use of a wide window on the leading edge W.

There is a narrow central corridor C, in which the passengers could move fast in reloadings, or to the immediate back-compartments in flight behind every 10 or 12 travellers. So in fligth there is no need for rushing to the other side of the system into the singular match-box sized British lavatory.

Referring to FIG. 5 a cushion-like floating breakwater BW is designed from the cheapest and the best flexible material, the rubberized chicken wire, from which a plurality could be anchored to the bottom alongside a sea-landing strip, without which the ground-effect aircraft could not be very useful.

1. A Ground-Effect Aircraft and Airfield in a systemic unity in which the very low level flying aircraft is always so close to the ground, which is mostly sea-water, that it could land on the water at any time, but most preferably on a smooth water, framed specially with light air-filled floating breakwaters alongside of whole landing strips, and the aircraft is a large body of a mass-transporter, whose wide-span wing is the actual transporter, quickly separable from the long, double-bubble fuselage, having a wide span canard wing at the front and a big rocket-like engine at its tail, with two long side keels at the bottom for causing a strong air-cushion in landing, while in flight the big wing is permanently stabilized with two separate tail planes, particularly useful in damping the wings from flutter.

2. A Ground-Effect Aircraft and Airfield as claimed in claim 1 which is a large mass-transporter, capable of carrying 500 or more passengers in its wings, offering to its passengers always a wide panoramic view, which is quickly removable from the fuselage at passengers exchangings, so there is a possibility to serve a singular wing with two fuselages, or in another word the wing could fly a lot more time, parhaps twice as much as today.

3. A Ground-Effect Aircraft and Airfield as claimed in claims 1 and 2 whose fuselage is a large and long double-bubble structure, designed for carying fuel, and a wide canard wing at its frontal part, a great rocket-like engine at its tail, and a specially designed top surface at its quick fastenings to the main wing, but at its lower longitudinal sides it has two deep knife-edge-keels for developing a strong air-cushion in landing.

4. A Ground-Effect Aircraft and Airfield whose main wing has two tail-planes operating in separation from each other by cutting out unrequired flutter, making the wing extra-stable, what the canard could not offer, and the two verticals of the tail-planes are touching the water in landing, capable to employ inflatables for lifting the big wing under the act of the fast separation from the fuselage, while the passenger are emptying or reloading the wing quickly, and another, fully filled fuselace could arrive.

5. A Ground-Effect Aircraft and Airfield as claimed in any of the previous claims, which could land on any sea, but most especially on a smooth water framed from the big waves by means of air-filled floating bodies in two or three layers, strongly anchored to the bottom, not too far from a coastal holyday resource, but in fact very much nearer to London, Los-Angeles, New York, Chicago, or Rio de Janeiro, Tokyo, or Sydney, than any of their prsently used airfields.
